(19) United States
(12) Patent Application Publication
(10) Pub. No.: US 2008/0133785 A1
(43) Pub. Date: Jun. 5, 2008

(54) OPTICAL POINTING DEVICE AND DATA TRANSMISSION METHOD THEREOF

(75) Inventors: Jong-Taek KWAK, Yongin-si (KR); Bang-Won LEE, Yongin-si (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 11/849,502

(22) Filed: Sep. 4, 2007

(30) Foreign Application Priority Data
Dec. 1, 2006 (KR) 1020060120852

(51) Int. Cl. G06F 3/14

(52) U.S. Cl. 710/20

(57) ABSTRACT

Provided are an optical pointing device and a data transmission method thereof. The optical pointing apparatus includes: an optical pointing sensing part for receiving an image of a subject to output digital image data and a motion value; an input signal analysis part for receiving a command from the host computer and analyzing the type of the command to output first and second operation control signals; a data input/output controller for outputting the motion value in response to the first operation control signal and outputting the digital image data in response to the second operation control signal; and a computer interface for receiving the motion value and the digital image data having different data transmission protocols to directly transmit the value and the data to the host computer. Therefore, it is possible to accurately analyze an optical state in the optical pointing device and detect defects in an image sensor and peripheral parts, and transmit image data to a host computer having different data protocol, without separating an optical pointing device chip from a printed circuit board in the optical pointing device and risking damage to the printed circuit board.

### CROSS-REFERENCE TO RELATED APPLICATION

This application claims the benefit of Korean Patent Application No. 2006-120852, filed Dec. 1, 2006, the disclosure of which is hereby incorporated herein by reference in its entirety.

### BACKGROUND OF THE INVENTION

1. Field of the Invention

The present invention relates to an optical pointing device, and more particularly, to an optical pointing device functioning as a computer interface and a data transmission method thereof capable of directly connecting the computer interface to a host computer through data transmission using a different protocol than defined by the host computer.

2. Description of the Related Art

An optical mouse, one type of optical pointing device, is a basic peripheral device of a computer. The optical mouse employs an optical sensor device chip to rapidly calculate its speed and direction of movement and thereby determine its coordinates. In recent years, the optical mouse has largely replaced a ball mouse.

The optical mouse transmits basic information such as optical mouse movement information in X- and Y-directions, input information of a selection button, scroll information of a wheel, and image information data of a work surface to a host computer.

The optical mouse movement information is movement information obtained from correlation between image information of the work surface continuously collected by an image sensor and previously collected image data.

The input information of the selection button is for selecting or executing a program upon which a curser is disposed on a predetermined display device such as a monitor. When the selection button is single-clicked, a program selection signal is output, and when the selection button is double-clicked, a program execution signal is output.

The scroll information of the wheel is for scrolling a display screen up and down in units of single lines of each page to search for desired data.

The image information of the work surface is, on which the mouse is located, receiving an image of a subject to generate an analog signal, converting the received signal into a digital signal, and outputting the digital signal.

Meanwhile, methods of connecting an optical pointing device to a host computer may be classified into those employing wires and those not employing wires. Connection methods employing wires are further classified into PS/2-type connection methods and USB-type connection methods. Recently, with the rapid popularization of handheld digital input/output devices such as digital cameras, digital camcorders, MP3 players, and so on, which are connectable to USB ports found in most computers and having a simple and stable signal system, USB-type connections are more widely used than PS/2-type connections. In addition, wireless connection methods employing a wireless data transmission/reception part are also widely used.

FIG. 1 is a block diagram showing a data transmission between a conventional optical pointing device and a host computer. The data transmission system includes a button part 10, a scroll part 20, a button/scroll signal input part 30, an optical pointing device chip 40, a computer interface part 50, and a host computer 60. The optical pointing device chip 40 includes an optical pointing sensing part 45 and a data input/output controller 47. The optical pointing sensing part 45 includes an optical part 41, an image sensor 42, an A/D converter 43, and a motion value calculation part 44.

The function of each block shown in FIG. 1 will be described below.

The button part 10 includes a selection button 11 and a menu button 12. The selection button is used to select or execute a program on which a curser is positioned on a display device, and the menu button 12 is used to display a menu for a program on which the curser is positioned. The button part 10 outputs input information of the selection button 11 and the menu button 12.

The scroll part 20 is formed of a wheel, a touch pad, or the like, to output scroll input information for vertically scrolling a screen of the display device connected to the host computer 60 in response to user manipulation.

The button/scroll signal input part 30 receives input information of the selection button 11 of the button part 10 to output a program selection or program execution signal depending on the number of clicks, receives input information of the menu button 12 to output a menu display signal for displaying various menus, and receives scroll input information from the scroll part 20 to output a screen scroll signal. In the case of the conventional two-button optical mouse, a left button is used as a selection button and a right button is used as a menu button.

The optical pointing sensing part 45 calculates a motion value V(MOV) using an optical image transmitted through the optical part 41. The optical part 41 is constituted of a light source, a lens, and other attachments. The light source radiates light onto a work surface, and light reflected from the work surface is transmitted to the image sensor 42 through the lens. The image sensor 42 receives the reflected light through the lens to detect image data, the A/D converter 43 receives an analog signal output from the image sensor 42 to convert it into a digital signal, and the motion value calculation part 44 calculates a motion value V(MOV) from the digital image data output from the A/D converter 43 to output the value.

The data input/output controller 47 receives the motion value V(MOV) output from the optical pointing sensing part 45, and a button information signal and a scroll information signal of the button/scroll signal input part 30, and outputs them.

The computer interface 50 receives the motion value V(MOV) and the button/scroll signal from the data input/output controller 60 to transmit them to the host computer 60. Here, they are transmitted to a PS/2 port or a USB port in the case of a wired device, or to a wireless data transmission/reception part in the case of a wireless device.

Operation of the conventional optical pointing device will be described below with reference to FIG. 1.

For example, it is provided that a computer user moves an optical mouse, an example of an optical pointing device, across a work surface in order to execute a predetermined program on a monitor, i.e., a display device connected to the host computer 60.

First, the computer user moves a curser of the optical mouse appearing on the monitor onto a program icon. Then, the user clicks the selection button 11 of the button part 10 once to select the program, or clicks the selection button 11 twice to execute the program.

In addition, in order to execute a program corresponding to an item on a menu, the user clicks the menu button 12, searches through the menu by moving the optical mouse itself, and clicks the selection button 11 at least once when the curser is located on the desired menu item.

The scroll part 20, such as the wheel or the touch pad, is manipulated to output a screen scroll signal for vertically scrolling the screen on the monitor in order to search for desired content within the framework of a program executed by the user.

The optical mouse moves in two dimensions across a coordinate plane. The image of the work surface is continuously received by the optical pointing sensing part 45 and converted into a digital signal corresponding to the movement of the optical mouse. The optical pointing sensing part 45 calculates a correlation value between current image data and previous image data, and outputs a motion value.

The program selection or execution signal of the button part 10, the screen scroll signal of the scroll part 20, and the optical mouse motion value V(MOV) of the optical pointing sensing part 45 are defined in a standard optical pointing device data format for optical pointing device compatibility, and are output periodically. A typical data format is formed of three or four bytes. In addition, data transmission speed is about 100 transmissions per second for USB connections and about 40 transmissions per second for PS/2 and wireless connections.

Such information is transmitted to the host computer 60 through the computer interface 50 and processed to move the curser on the monitor, select and execute programs, navigate menus, scroll through documents, and so on.

When the host computer receives digital image data collected by the conventional optical pointing device, two or three serial ports are required. Since a data transmission protocol employed at this time is different than defined by the computer interface port such as the PS/2 port or the USB port, it is impossible to directly connect the data transmission protocol to the host computer.

However, in order to output a plurality of bits of parallel digital image data, a plurality of output pins are required. In a pre-manufactured package of the optical pointing device chip 40, a button/scroll signal input pin, a control signal input pin, a power voltage pin, and so on, are each soldered onto a printed circuit board.

Therefore, in order for the host computer 60 to receive the digital image data from the optical pointing device and display it through the display device, pins other than data output pins must be used as data output pins. In addition, when there is concern about data collision, the optical pointing device chip may be disconnected from the printed circuit board and used separately to receive the digital image data. In this process, the conventional printed circuit board may be damaged.

### SUMMARY OF THE INVENTION

In order to solve the foregoing and/or other problems, it is an object of the present invention to provide an optical pointing device and a data transmission method thereof capable of directly transmitting image data collected by the optical pointing device to a host computer connected thereto, without separating an optical pointing device chip from a printed circuit board, and accurately analyzing an optical state in the optical pointing device and detecting defects in an image sensor and peripheral parts.

According to an aspect of the present invention, there is provided an optical pointing device including: an optical pointing sensing part for receiving an image of a subject to generate an analog signal, converting the analog signal into digital image data, and calculating a motion value from the digital image data to output the digital image data and the motion value; an input signal analysis part for receiving a video signal request command or a video signal output finish command from the host computer and analyzing the type of the command to output a first operation control signal and a second operation control signal; a data input/output controller for receiving the digital image data and the motion value to output the motion value in response to the first operation control signal and output the image data output command for outputting the digital image data in response to the second operation control signal; and a computer interface for receiving the video signal request command or the video signal output finish command to transmit the commands to the input signal analysis part, and commonly receiving the motion value and the digital image data having different data transmission protocols to directly transmit the motion value and the digital image data to the host computer.

The optical pointing device may further include a button/scroll signal input part for outputting a first signal to select or execute a predetermined program on a predetermined display device, outputting a second signal to execute the predetermined program with respect to various menu items, and outputting a third signal to vertically scroll a screen of the predetermined display device; and a multiplexer for receiving the digital image data and the motion value to selectively output the digital image data or the motion value under control of the image data output command.

The computer interface may be a PS/2 port or a USB port when the optical pointing device is a wired device, and a wireless data transmission/reception part when the optical pointing device is a wireless device.

The input signal analysis part may analyze whether the video signal request command or the video signal output finish command is a normal operation command for commanding output of the first to third signals and the motion value, or a specific operation command for commanding the start or finish of digital image data output.

The input signal analysis part may output a logic-high level of the second operation control signal when the specific operation command instructs start of the digital image data output, and a logic-low level of the second operation control signal when the specific operation command instructs finish of the digital image data output.

The specific operation command may be a direct command for a video signal output mode from the host computer, a combination of general commands of a normal operation mode, and may contain address information of a pixel position in the image sensor.

The optical pointing device may further include a button part for selecting or executing a program on which a curser is located on the display device, and outputting input information of a button to execute the program with respect to various menu items; and a scroll part for outputting scroll input information to vertically scroll the screen of the display device by operating a wheel or a touch pad.

The button part may include a selection button for manually inputting information to select or execute a program on which a curser is located on the predetermined display device; and a menu button for inputting information to execute a program with respect to various menu items.

The button/scroll signal input part may receive input information of the selection button to output a first signal depending on the number of clicks of the selection button, receive input information of the menu button to output a second signal for executing a program with respect to various menu items, and receive scroll input information to output a third signal.

The optical pointing sensing part may include an optical part for radiating light to an object through a light source, and receiving light reflected from the object to transmit an optical image; an image sensor for receiving the reflected light to detect image data and outputting an analog signal corresponding to the received luminous intensity; an A/D converter for receiving the analog signal and converting it into a digital signal; and a motion value calculation part for receiving an output signal of the A/D converter and comparing a difference between pixels to calculate and output a motion value.

According to another aspect of the present invention, there is provided a data transmission method of an optical pointing device including: a normal operation step of outputting a motion information signal of an optical pointing device to transmit the signal to a host computer so that the host computer performs a corresponding operation through a predetermined internal process thereof; a video signal output request step of outputting a video signal output request command when a video signal of the image collected by the optical pointing device is required during normal operation of the host computer; an input signal analysis step of receiving the video signal output request command to analyze the type of the command and outputting a specific operation start control signal when the command is analyzed as a first specific operation command; a video signal output command step of outputting a video signal output command to receive the specific operation start control signal and temporarily stop normal operation, and simultaneously to control start of a specific operation for outputting a video signal; and a host computer processing step of temporarily stopping output of the motion information signal of the optical pointing device in response to the video signal output command, and outputting the digital image data having different data transmission protocol from the motion information data of the optical pointing device to commonly and directly transmit the data to the host computer to perform a predetermined process therein.

The data transmission method of an optical pointing device may further include a first video signal output finish command step of outputting a first video signal output finish command stopping transmission of digital image data when the host computer completes a predetermined process; an input signal analysis step of receiving the video signal output finish command to analyze the type of the command and outputting a specific operation finish control signal when the command is analyzed as a second specific operation command; a second video signal output finish command step of receiving the specific operation finish control signal to stop digital image data output operation, and outputting a second video signal output finish command to control output of the temporarily stopped button information signal, the screen scroll signal, and the motion signal of the optical pointing device; and a step of stopping the digital image data output in response to the video signal output finish command, and restarting output of the button information signal, the screen scroll signal, and the motion signal of the optical pointing device, and performing normal operations corresponding thereto.

The video signal output request command may be an interrupt command temporarily stopping normal operation of the host computer and performing an operation required when a video signal is required.

The video signal output request command may be a specific operation command initiating a video signal output operation by the host computer.

The video signal output request command may be constituted of a plurality of normal operation commands including a first set corresponding to a specific operation command requesting output of a video signal of an image, and a second set corresponding to a specific operation command requesting finish of the output of the video signal of the image.

The video signal output finish command may be an interrupt command temporarily stopping output of the digital image data and restarting normal operation.

The video signal output request step may include outputting the first set of the plurality of normal operation commands when the host computer requires a video signal of an image collected by the optical pointing device during normal operation; receiving the first set of the plurality of normal operation commands and transmitting to the host computer a response signal that the first specific operation mode command is recognized; outputting the second set of the is plurality of normal operation commands when the host computer completes the desired operation; and receiving the second set of the plurality of normal operation commands and transmitting to the host computer a response signal that the second specific operation mode command is recognized.

The video signal output request command may include address information of a pixel position in an image sensor for receiving light reflected from a subject to detect image data.

In the normal operation step, the corresponding operation may be operation of a curser on a predetermined display, selection and execution of a program, navigation of a menu and execution of a program, and a scrolling operation of a screen of the predetermined display.

In the host computer processing step, the host computer may receive the digital image data to display the data on the screen of the predetermined display, store, or process further the data.

### BRIEF DESCRIPTION OF THE DRAWINGS

These and/or other objects, features and advantages of the present invention will become apparent and more readily appreciated from the following description of exemplary embodiments of the invention, taken in conjunction with the accompanying drawings of which:

FIG. 1 is a block diagram showing data transmission between a conventional optical pointing device and a host computer;

FIG. 2 is a block diagram showing data transmission between an optical pointing device and a host computer in accordance with an exemplary embodiment of the present invention;

FIG. 3 is a diagram showing a data transmission operation of an optical pointing device in accordance with an exemplary embodiment of the present invention; and

FIG. 4 is a diagram showing a data transmission operation of an optical pointing device in accordance with another exemplary embodiment of the present invention.

### DETAILED DESCRIPTION OF THE INVENTION

Reference will now be made in detail to exemplary embodiments of the present invention, examples of which are illustrated in the accompanying drawings.

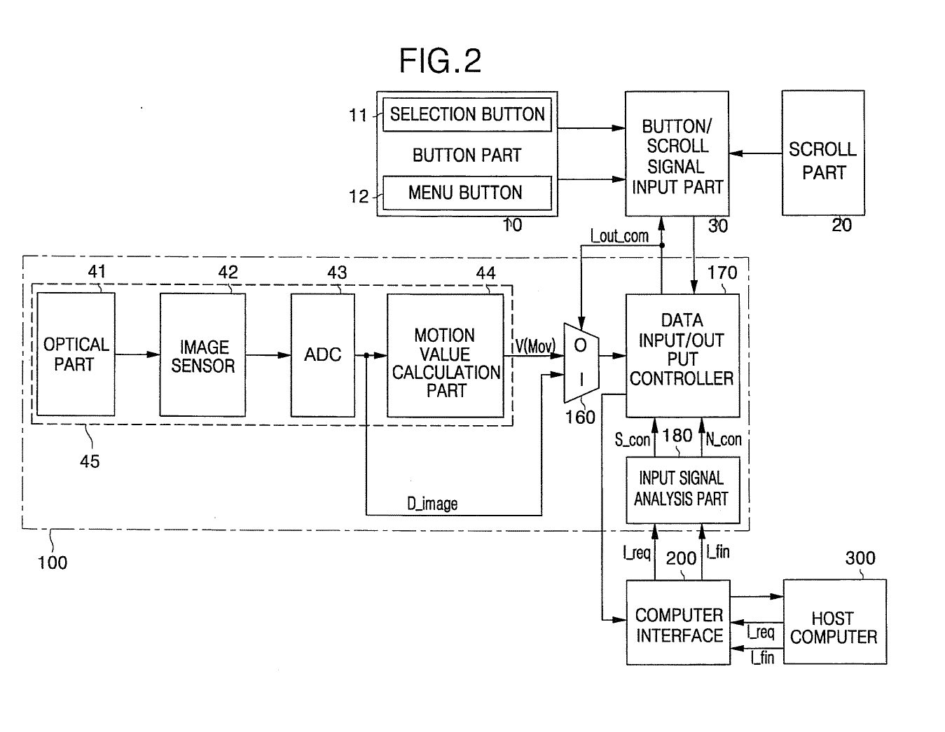

FIG. 2 is a block diagram showing data transmission between an optical pointing device and a host computer in accordance with an exemplary embodiment of the present invention, including a button part 10, a scroll part 20, a button/scroll signal input part 30, an optical pointing device chip 100, a computer interface 200, and a host computer 300. The optical pointing device 100 includes an optical pointing sensing part 45, a multiplexer 160, a data input/output controller 170, and an input signal analysis part 180. The optical pointing sensing part 45 includes an optical part 41, an image sensor 42, an A/D converter 43, and a motion value calculation part 44.

The function of each block shown in FIG. 2 will be described.

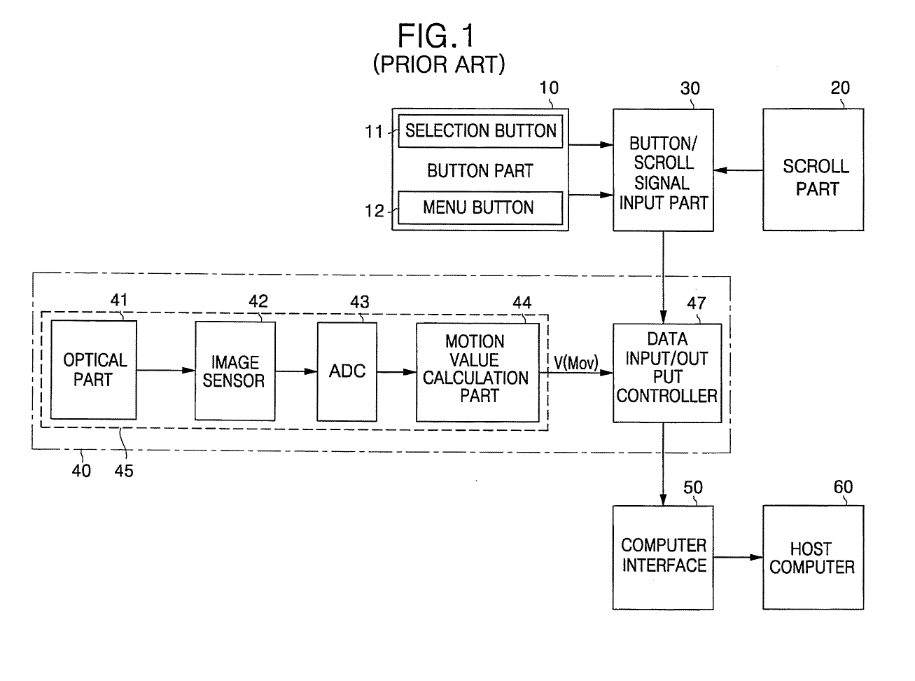

The button part 10, the scroll part 20, and the button/scroll signal input part 30 have the same functions as their counterparts shown in FIG. 1, and thus, their description will not be repeated. Only blocks having different functions will be described below.

The input signal analysis part 180 receives a video signal output request command I_req and a video signal output finish command I_fin for requesting a video signal of an image of work surface from the host computer 300, analyzes whether the command is a normal operation command or a specific operation command, and outputs a normal operation control signal N_con or a specific operation control signal S_con.

Here, the host computer uses the normal operation command to control characteristics of the optical pointing device. When the host computer is a personal computer, the normal operation command is set by a device driver. Typical control characteristics may include a click speed and a pointer speed of the optical pointing device. While the normal operation control signal N_con is standardized for compatibility with other computers, the specific operation control signal S_con is made for the present invention only.

That is, when the command is analyzed as the normal operation command relating with the screen scroll signal, the button information signal, and the motion value V(MOV) of the optical pointing device, the normal operation control signal N_con is output. And, when the command is analyzed as the specific operation command relating with start and finish of the digital image data, the specific operation control signal S_con is output.

In addition, when the specific operation command is starting output of the digital image data, a logic-high level of a specific operation control signal S_con is outputted, and when specific operation command is finishing output of the digital image data, a logic-low level of a specific operation control signal S_con is outputted.

The optical pointing sensing part 45 receives an image of a subject to generate an analog signal, converts the received analog signal into a digital signal, and calculates a motion value V(MOV) from the converted image data, thereby outputting the digital image data and the motion value V(MOV).

The multiplexer 160 receives the digital image data and the motion value V(MOV) to selectively output the digital image data or the motion value V(MOV) under control of a video signal output command signal I_out_com of the data input/output controller 170.

That is, when the video signal output command signal I_out_com is at a logic-high level, the digital image data D_image is output, and when the video signal output command signal I_out_com is at a logic-low level, the motion value V(MOV) is output.

The data input/output controller 170 receives a screen scroll signal and a button information signal form the button/scroll signal input part 30, and receives digital image data D_image or a motion value V(MOV) from the optical pointing sensing part 45. This enables it to output the screen scroll signal, the button information signal, and the motion value V(MOV) in response to the normal operation control signal N_con, and output the video signal output command signal I_out_com of starting and finishing output of the digital image data D_image in response to the specific operation control signal S_con.

The computer interface 200 receives a motion data transmission request of the optical pointing device through the PS/2 port or the USB port when the optical pointing device is a wired device, and through the wireless data transmission/reception part when the optical pointing device is a wireless device. It transmits the request to the input signal analysis part 180 and receives the screen scroll signal, the button information signal, and the motion value V(MOV) or the digital image data D_image from the data input/output controller 170 to transmit the motion value or the digital image data to the host computer 300.

Operation of the optical pointing device in accordance with the present invention will be described with reference to FIG. 2.

It is provided that a computer user moves an optical mouse, an example of an optical pointing device, on a work surface in order to execute a predetermined program on a monitor, i.e., a display device connected to the host computer 300.

First, the computer user clicks the selection button 11 of the button part 10 once to select the program, or clicks the selection button 11 twice to execute the program. And in order to execute the program in connection with an item on a menu, the user clicks the menu button 12, searches through the menu, and clicks the selection button 11 at least once. This is similar to operation of the conventional optical pointing device shown in FIG. 1.

In addition, output of the screen scroll signal depending on manipulation of the scroll part 20, operation of receiving an image of the work surface through the optical pointing sensing part 45 depending on movement of the optical mouse, conversion of the image into a digital image, calculation of a correlation value with previous data to output a motion value V(MOV) on a coordinate plane of the optical mouse itself, and operation of a curser on the monitor corresponding to transmission of the various signals to the host computer 300 through the data input/output controller 170 and the computer interface 200, are similar to operations of the conventional optical pointing device shown in FIG. 1.

In contrast to FIG. 1, the computer interface 200 receives the command I_req to directly transmit the command to the input signal analysis part 180 in the optical pointing device chip installed in the optical pointing device through the PS/2 port, the USB port, or the wireless data transmission/reception part. In addition, the input signal analysis part 180 receives the video signal output request command I_req to analyze it as a specific command for a video signal output mode, not a normal operation mode, and thus performs the following operation.

At this time, the specific command may be a direct command for a specific operation mode of a video signal output mode from the host computer 300, may be a set of combined commands of the normal operation mode, or may include address information of a pixel position in the image sensor 42 for outputting image data.

The input signal analysis part 180 outputs a logic-high level of a specific operation control signal S_con when the transmitted video signal output request command I_req is analyzed as a specific command for the video signal output mode, and the data input/output controller 170 receives the control signal S-con and outputs a logic-high level of a video signal output command signal I_out_com in order to output the digital image data D_data of the optical pointing sensing part 45.

Meanwhile, the optical pointing sensing part 45 receives an image of a work surface through the image sensor 42 depending on movement of the optical mouse to generate an analog signal, the A/D converter 43 receives the analog signal and converts it into a digital signal to output digital image data D_image, and the motion value calculation part 44 calculates a motion value V(MOV) from the data D_image to output the motion value.

The button/scroll signal input part 30 temporarily stops output of the button information signal and the screen scroll signal in response to a logic-high level of the video signal output command signal I_out_com, and the multiplexer 160 receives the digital image data D_image and the motion value V(MOV) to start output of the digital image data D_image in response to the logic-high level of the video signal output command signal I_out_com.

The digital image data D_image is transmitted to the host computer 300 via the data input/output controller 170 and the computer interface 200 to be displayed on the monitor screen, stored, or processed further.

At this time, the digital image data D_image is mixed with the conventional button information signal, the scroll signal, and a standard optical pointing device data format of the optical mouse motion value V(MOV) and output therewith. In the case of a USB1.1 connection, a data transmission speed is 2.4 kbit/sec, when a three-byte standard optical pointing device data format is transmitted 100 times per second (called as USB report rate) within a wave bandwidth of a maximum 12 Mbit/sec.

Therefore, since the maximum transmission speed is 120 kbit/sec per one USB report rate, 20×20 pixel data can be transmitted with thirty frames. Therefore, it is possible to simultaneously display operation of the optical pointing device and image data of the work surface on the monitor screen.

The host computer 300 outputs the video signal output finish command I_fin in an interrupt command format that no digital image data D_image is necessary further.

The input signal analysis part 180 receives the video signal output finish command I_fin through the computer interface 200 and analyzes whether the command I_fin is a specific command. When a logic-low level of the specific operation control signal S_con is outputted, the data input/output controller 170 receives the control signal S_con to output a logic-low level of the video signal output command signal I_out_com in order to complete output of the digital image data D_image of the optical pointing sensing part 45.

The multiplexer 160 receives the digital image data D_image and the motion value V(MOV) and outputs only the motion value V(MOV) on the coordinate plane of the optical mouse in response to a logic-low level of the video signal output command signal I_out_com. Here, the output operation of the digital image data D_image can be stopped. And, the button/scroll signal input part 30 restarts the temporarily stopped output of the button information signal and the screen scroll signal in response to a logic-low level of the video signal output finish command I_fin.

While FIG. 2 illustrates the video signal output request command I_req and the video signal output finish command I_fin using separate lines, the commands may be implemented as a portion of a communication protocol between the host computer 300 and the computer interface 200. In addition, the video signal output request command I_req and the video signal output finish command I_fin may be generated by the button part 10 or the scroll part 20.

The host computer 300 receives the motion value V(MOV) on the coordinate plane of the optical mouse, the button information signal, and the screen scroll signal through the data input/output controller 170 and the computer interface 200 to perform the predetermined internal process and repeat normal operations such as operation of the curser on the monitor corresponding thereto, selection and execution of the corresponding program, menu navigation and program execution, scroll operation of the monitor screen, and so on.

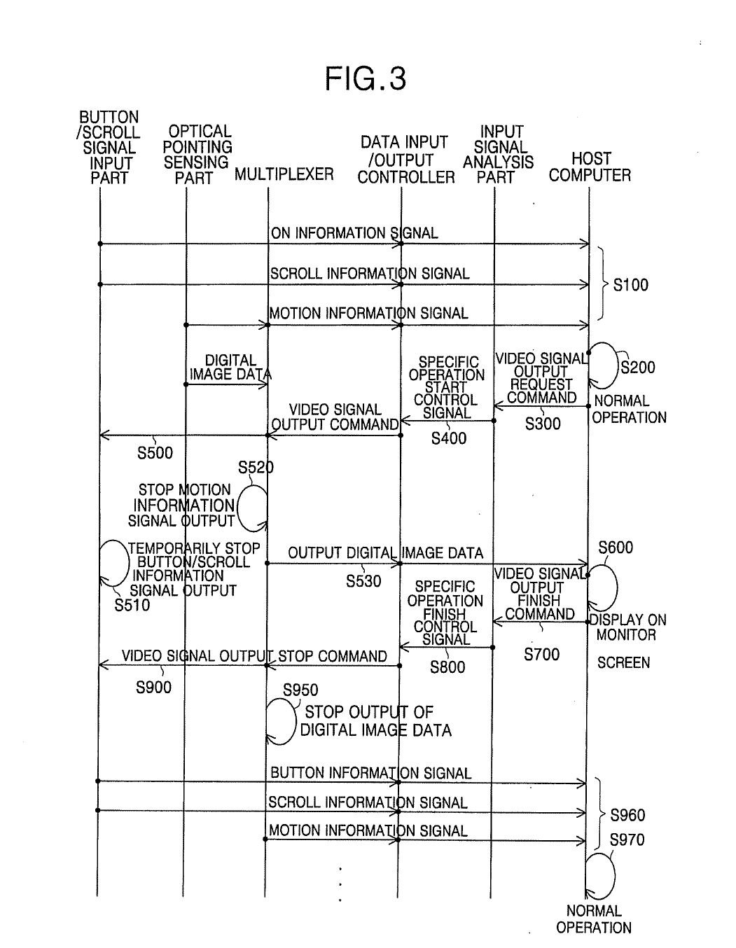

Next, FIG. 3 is a diagram showing a data transmission operation of an optical pointing device in accordance with an exemplary embodiment of the present invention.

An image data transmission operation of the optical pointing device in accordance with an exemplary embodiment of the present invention will be described with reference to FIGS. 2 and 3.

The optical pointing device outputs button information signals such as a signal for selecting and executing a program desired by a computer user and a signal for executing a program with respect to various menu items, and outputs a screen scroll signal for searching for desired content from the program in process.

Meanwhile, the optical pointing sensing part 45 receives an image of the work surface depending on movement of the optical mouse to generate an analog signal, converts the analog signal into a digital signal to output digital is image data D_image, and calculates a motion value V(MOV) from the data to output the motion value.

The multiplexer 160 receives the digital image data D_image and the movement value V(MOV) from the optical pointing sensing part 45 to selectively output the data or the value under control of the video signal output command signal I_out_com. Since a logic-low level of the video signal output command signal I_out_com is applied in the normal mode, the motion value V(MOV) is output.

The button information signal and the screen scroll signal output from the button/scroll signal input part 30 and the motion value V(MOV) output from the multiplexer 160 are transmitted to the host computer 300 through the data input/output controller 170 and the computer interface 200 (S100).

The host computer 300 receives the signals, and, after performing a predetermined internal process, performs normal operations such as operation of a curser on the monitor, selection and execution of a program, menu navigation and program execution, scroll operation of the monitor screen, and so on (S200).

The host computer 300 temporarily stops the operation in progress during normal operation in order to request a video signal of an image of the work surface collected by the optical pointing device, and outputs the video signal output request command I_req in an interrupt command format to perform the required operation (S300).

The input signal analysis part 180 receives the video signal output request command I_req through the computer interface 200 to analyze whether the command is a normal operation command or a specific operation command such as a video signal output operation, etc.

In this exemplary embodiment, since the video signal output request command I_req is a specific operation command directly commanding a video signal output operation from the host computer 300, the input signal analysis part 180 analyzes that the video signal output request command I_req is a specific command for the video signal output mode, and outputs a logic-high level of a specific operation control signal S_con (S400).

At this time, the video signal output request command I_req may include address information of a pixel position in the image sensor 42 for outputting image data.

The data input/output controller 170 receives the control signal S_con and outputs the video signal output command signal L_out_com for temporarily stopping normal operation of the button/scroll signal input part and simultaneously controlling the start of a specific operation for outputting a video signal of an image of the work surface collected by the optical pointing sensing part 45 (S500).

Since a logic-high level of the video signal output command signal I_out_com is applied in the specific operation start mode, the button/scroll signal input part 30 temporarily stops output of the button information signal and the screen scroll signal (S510), and the multiplexer 160 receives the digital image data D_image and the motion value V(MOV) from the optical pointing sensing part 45 to output the digital image data D_image (S520).

The digital image data D_image is transmitted to the host computer 300 through the data input/output controller 170 and the computer interface 200. The host computer 300 receives the digital image data D_image, performs a predetermined process on it and displays it on the monitor screen, or stores it in text (S600).

When the desired operation is completed, the host computer 300 outputs the video signal output finish command I_fin in an interrupt command format to stop the provision of image data (S700).

The input signal analysis part 180 receives the video signal output finish command I_fin to analyze whether the command is a specific operation command or not. In this exemplary embodiment, similar to the video signal output request command I_req, the input signal analysis part 180 analyzes that the command is a specific operation command directly commanding termination of video signal output from the host computer 300, and outputs a logic-low level of the specific operation control signal S_con (S800).

The data input/output controller 170 receives the control signal to stop a specific operation of outputting a video signal of the work surface collected by the optical pointing sensing part 45, and outputs a logic-low level of the video signal output command I_out_com for outputting only the motion value V(MOV) of the optical mouse and simultaneously restarting the normal operation of outputting the button information signal and the screen scroll signal temporarily stopped by the button/scroll signal input part 30 (S900).

Since a logic-low level of the video signal output command signal I_out_com is applied in the specific operation finish mode, the multiplexer 160 stops output of the digital image data D_image (S950) and outputs the motion value V(MOV), and the button/scroll signal input part 30 restarts output of the button information signal and the screen scroll signal (S960).

The host computer 300 receives the motion value V(MOV), the button information signal and the screen scroll signal of the coordinate plane of the optical mouse through the data input/output controller 170 and performs a internal predetermined process which restarts normal operations such as an operation of a curser on the monitor, selection and execution of a program, menu navigation and program execution, a scroll operation of the monitor screen, and so on (S970).

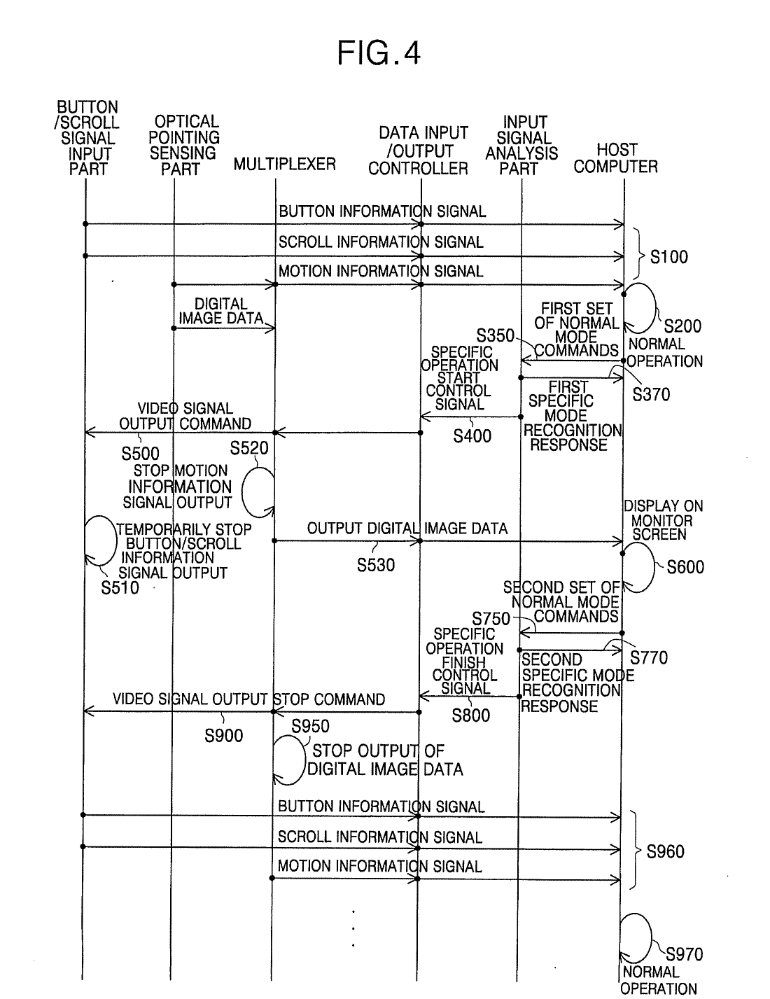

Next, FIG. 4 is a diagram showing a data transmission operation of an optical pointing device in accordance with another exemplary embodiment of the present invention.

In contrast to FIG. 3, the normal mode commands of the exemplary embodiment of FIG. 4 are normal operation commands individually, not specific operation commands for directly commanding a video signal output operation from the host computer 300 like the exemplary embodiment of FIG. 3. However, a first set of the normal operation commands is a first specific operation command requesting output of a video signal of an image collected from the work surface, and a second set of the normal operation commands is a second specific operation command requesting termination of output of the video signal of the image.

At this time, the video signal output request command I_req may include address information of a pixel position in the image sensor 42 for outputting image data.

Hereinafter, data transmission of image data of the optical pointing device in accordance with an exemplary embodiment of the present invention will be described with reference to FIGS. 2 and 4.

First, similar to the exemplary embodiment of FIG. 3, a computer user outputs the button information signal and the scroll information signal through the button/scroll signal input part 30, and a motion information signal on a coordinate plane of the optical mouse through the optical pointing sensing part 45 and the multiplexer 160, to transmit the signals to the host computer via the data input/output controller 170 and the computer interface 200 (S100).

The host computer 300 receives the signals, and, after performing a predetermined internal process, performs normal operations such as operation of a curser on the monitor, selection and execution of a program, menu navigation and program execution, scroll operation of the monitor screen, and so on (S200).

The host computer 300 outputs the video signal output request command I_req in an interrupt command format to perform the required operation during normal operation in order to request a video signal of an image of the work surface collected by the optical pointing device. At this time, in contrast to the exemplary embodiment of FIG. 3, the first set of the normal mode commands is output (S350).

The input signal analysis part 180 analyzes whether the command is a normal operation command or a specific operation command such as a video signal output operation and so on.

As described above, since the first set of the commands is the first specific operation command requesting output of a video signal of an image, the input signal analysis part 180 transmits to the host computer 300 a response signal that the first specific operation mode command is recognized (S370), and outputs a logic-high level of the specific operation control signal S_con for controlling start of output of a video signal of an image through the optical pointing device (S400).

Then, the data input/output controller 170 receives the control signal to output a video signal output start command (S500), the button/scroll signal input part 30 temporarily stops output of the button information signal and the screen scroll signal (S510), the multiplexer 160 outputs the digital image data D_image (S530), and the host computer 300 receives the digital image data D_image to display it on the monitor screen or store it in text (S600). These operations are the same as in the exemplary embodiment of FIG. 3.

Meanwhile, the host computer 300 outputs the second set of the normal mode commands in an interrupt command format stopping the provision of image data when the desired operation is completed (S750).

The input signal analysis part 180 receives the video signal output finish command I_fin to analyze whether the command is a specific operation command or not. In this exemplary embodiment, since the second set of the commands is a second specific operation command finishing output of the video signal of the image, the input signal analysis part 180 transmits to the host computer 300 a response signal that the second specific operation mode command is recognized (S770), and the optical pointing device outputs a logic-low level of the specific operation control signal S_con for finishing output of the video signal of the image (S800).

Then, the data input/output controller 170 outputs a logic-low level of the video signal output command I_out_com (S900), the multiplexer 160 stops output of the digital image data D_image (S950) and outputs the motion value V(MOV), the button/scroll signal input part 30 restarts output of the button information signal and the screen scroll signal (S960), and the host computer 300 receives the signals to restart normal operations (S970). These operations are the same as in the exemplary embodiment of FIG. 3.

While it is described above with reference to FIGS. 3 and 4 that only the digital image data is output when there is a video signal output request, the button information signal and the scroll information signal transmitted during normal operation may also be transmitted together with the digital image data.

As described above, the digital image data of the optical pointing device in accordance with an exemplary embodiment of the present invention may be used in inline inspection during a process of manufacturing the optical pointing device, or may be used to precisely mount a light source, a lens, and a lower plastic structure thereon.

In addition, the digital image data of the optical pointing device in accordance with an exemplary embodiment of the present invention may be used for the purpose of ensuring quality and providing after-sale service of the optical pointing device. Since optical misalignment caused by dropping the optical pointing device is common, being able to readily determine misalignment through the digital image data is important.

As can be seen from the foregoing, an optical pointing device and a data transmission method thereof in accordance with the present invention can accurately analyze an optical state in the optical pointing device and detect defects in an image sensor and peripheral parts, and can transmit image data to a host computer having different data protocol, without separating an optical pointing device chip from a printed circuit board in the optical pointing device.

Although a few exemplary embodiments of the present invention have been shown and described, it will be appreciated by those skilled in the art that various changes may be made to these exemplary embodiments without departing from the principles and spirit of the invention, the scope of which is defined by the appended claims and their equivalents.

What is claimed is:

1. An optical pointing device comprising:
an optical pointing sensing part for receiving an image of a subject to generate an analog signal, converting the analog signal into digital image data, and calculating a motion value from the digital image data to output the digital image data and the motion value;
an input signal analysis part for receiving a video signal request command or a video signal output finish command from the host computer and analyzing the type of the command to output a first operation control signal and a second operation control signal;
a data input/output controller for receiving the digital image data and the motion value to output the motion value in response to the first operation control signal and output the image data output command for outputting the digital image data in response to the second operation control signal; and
a computer interface for receiving the video signal request command or the video signal output finish command to transmit the commands to the input signal analysis part, and commonly receiving the motion value and the digital image data having different data transmission protocols to directly transmit the motion value and the digital image data to the host computer.

2. The optical pointing device according to claim 1, further comprising:
a button/scroll signal input part for outputting a first signal to select or execute a predetermined program on a predetermined display device, outputting a second signal to execute the predetermined program with respect to various menu items, and outputting a third signal to vertically scroll a screen of the predetermined display device; and
a multiplexer for receiving the digital image data and the motion value to selectively output the digital image data or the motion value under control of the image data output command.

3. The optical pointing device according to claim 2, wherein the computer interface is a PS/2 port or a USB port when the optical pointing device is a wired device, and a wireless data transmission/reception part when the optical pointing device is a wireless device.

4. The optical pointing device according to claim 2, wherein the input signal analysis part analyzes whether the video signal request command or the video signal output finish command is a normal operation command for commanding output of the first to third signals and the motion value, or a specific operation command for commanding the start or finish of digital image data output.

5. The optical pointing device according to claim 4, wherein the input signal analysis part outputs a logic-high level of the second operation control signal when the specific operation command instructs start of the digital image data output, and outputs a logic-low level of the second operation control signal when the specific operation command instructs finish of the digital image data output.

6. The optical pointing device according to claim 5, wherein the specific operation command is a direct command for a video signal output mode from the host computer, is combination of general commands of a normal operation mode, or contains address information of a pixel position in the image sensor.

7. The optical pointing device according to claim 5, wherein the specific operation command is applied to the button/scroll signal input part.

8. The optical pointing device according to claim 1, further comprising:
a button part for selecting or executing a program on which a curser is located on the display device, and outputting input information of a button to execute the program with respect to various menu items; and
a scroll part for outputting scroll input information to vertically scroll the screen of the display device by operating a wheel or a touch pad.

9. The optical pointing device according to claim 8, wherein the button part comprises:
a selection button for inputting information to select or execute a program on which the curser is located on the predetermined display device; and
a menu button for inputting information to execute a program with respect to various menu items.

10. The optical pointing device according to claim 2, wherein the button/scroll signal input part receives input information of the selection button to output a first signal depending on the number of clicks of the selection button,
receives input information of the menu button to output a second signal for executing the program with respect to various menu items, and
receives scroll input information to output a third signal.

11. The optical pointing device according to claim 1, wherein the optical pointing sensing part comprises:
an optical part for radiating light to an object through a light source, and receiving light reflected from the object to transmit an optical image;
an image sensor for receiving the reflected light to detect image data and outputting an analog signal corresponding to the received luminous intensity;
an A/D converter for receiving the analog signal and converting it into a digital signal; and
a motion value calculation part for receiving an output signal of the A/D converter and comparing a difference between pixels to calculate and output a motion value.

12. The optical pointing device according to claim 2, wherein the data input/output controller receives the first to third signals, the motion value and the digital image data and in response to the first operation control signal, primarily transmits the first to third signals and the motion value, and transmits the digital image data in spare time.

13. A data transmission method of an optical pointing device, comprising:
a normal operation step of outputting a motion information signal of an optical pointing device to transmit the signal to a host computer so that the host computer performs a corresponding operation through a predetermined internal process thereof;
a video signal output request step of outputting a video signal output request command when a video signal of the image collected by the optical pointing device is required during normal operation of the host computer;
an input signal analysis step of receiving the video signal output request command to analyze the type of the command and outputting a specific operation start control signal when the command is analyzed as a first specific operation command;
a video signal output command step of outputting a video signal output command to receive the specific operation start control signal and temporarily stop normal operation, and simultaneously to control start of a specific operation for outputting a video signal; and
a host computer processing step of temporarily stopping output of the motion information signal of the optical pointing device in response to the video signal output command, and outputting the digital image data having different data transmission protocol from the motion information data of the optical pointing device to commonly and directly transmit the data to the host computer to perform a predetermined process therein.

14. The data transmission method according to claim 13, further comprising:
a first video signal output finish command step of outputting a first video signal output finish command stopping transmission of digital image data when the host computer completes a predetermined process; an input signal analysis step of receiving the video signal output finish command to analyze the type of the command and outputting a specific operation finish control signal when the command is analyzed as a second specific operation command;
a second video signal output finish command step of receiving the specific operation finish control signal to stop digital image data output operation, and outputting a second video signal output finish command to control output of the temporarily stopped button information signal, the screen scroll signal, and the motion signal of the optical pointing device; and
a step of stopping the digital image data output in response to the video signal output finish command, and restarting output of the button information signal, the screen scroll signal, and the motion signal of the optical pointing device, and performing normal operations corresponding thereto.

15. The data transmission method according to claim 13, wherein the video signal output request command is an interrupt command temporarily stopping normal operation of the host computer and performing an operation required when a video signal is required.

16. The data transmission method according to claim 15, wherein the video signal output request command is a specific operation command initiating a video signal output operation by the host computer.

17. The data transmission method according to claim 15, wherein the video signal output request command is constituted of a plurality of normal operation commands,
a first set of the plurality of normal operation commands is a first specific operation command requesting output of a video signal of an image, and
a second set of the plurality of normal operation commands is a second specific operation command requesting finish of the output of the video signal of the image.

18. The data transmission method according to claim 14, wherein the video signal output finish command is an interrupt command temporarily stopping output of the digital image data and restarting normal operation when the desired operation is completed while the host computer receives the digital image data.

19. The data transmission method according to claim 13, wherein the video signal output request step comprises:
outputting the first set of the plurality of normal operation commands when the host computer requires a video signal of an image collected by the optical pointing device during normal operation;
receiving the first set of the plurality of normal operation commands and transmitting to the host computer a response signal that the first specific operation mode command is recognized;
outputting the second set of the plurality of normal operation commands when the host computer completes the desired operation; and
receiving the second set of the plurality of normal operation commands and transmitting to the host computer a response signal that the second specific operation mode command is recognized.

20. The data transmission method according to claim 13, wherein the video signal output request command comprises address information of a pixel position in an image sensor for receiving light reflected from a subject to detect image data.

21. The data transmission method according to claim 13, wherein, in the normal operation step, the corresponding operation is operation of a curser on a predetermined display, selection and execution of a program, navigation of a menu and execution of a program, and a scrolling operation of a screen of the predetermined display.

22. The data transmission method according to claim 13, wherein, in the host computer processing step, the host computer receives the digital image data to display the data on the screen of the predetermined display or store the data in text through the predetermined process.
